(19) United States
(12) Patent Application Publication
(10) Pub. No.: US 2008/0011336 A1
(43) Pub. Date: Jan. 17, 2008

(54) INDUCTION HEATING TYPE PURE WATER HEATING APPARATUS AND PURE WATER HEATING METHOD

(75) Inventor: Maki HAMAGUCHI, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/773,103

(22) Filed: Jul. 3, 2007

(30) Foreign Application Priority Data
Jul. 11, 2006 (JP) 2006-190472

(51) Int. Cl. B08B 3/00

(52) U.S. Cl. 134/105

(57) ABSTRACT

Disclosed is an induction heating type pure water heating apparatus capable of heating pure water with efficiency and without contaminating pure water. The apparatus is characterized by including a susceptor formed of glassy carbon with a water absorption coefficient of 0.5 mass % or less, and capable of contacting with pure water, a container made of a magnetic flux transmissive material, and formed so as to accommodate the susceptor and so as to allow pure water to pass therethrough, and an induction coil disposed in such a state as to surround the container or as to be adjacent to the container.

### BACKGROUND OF THE INVENTION

1. Field of the Invention

The present invention relates to an induction heating type pure water heating apparatus and a pure water heating method, for heating pure water by induction heating.

2. Description of the Related Art

Conventionally, pure water has been used for cleaning a wafer or a glass substrate in a manufacturing process of a semiconductor or a liquid crystal. Ultrapure water has also come into use as manufacturing of a semiconductor has become advanced.

The pure water including ultrapure water is heated for enhancing the cleaning effect, and is used as heated pure water.

Whereas, heated pure water can also be used for the purpose of cleaning an object to be cleaned in, for example, the medical or food field other than the foregoing fields.

Heated pure water can be obtained by various heating systems such as resistance heating, lamp heating, and induction heating. However, the heating apparatuses therefor are demanded to meet the following respective requirements: they are high in heating efficiency; they do not contaminate pure water; the maintenance is easy; and the like.

As the apparatuses utilizing induction heating, there are known a heating apparatus in which a resistance heating heater is disposed outside a pure water container to indirectly heat pure water; and a heating apparatus in which a heater is immersed inside a pure water container to directly heat pure water.

As for the lamp heating, there is known an apparatus which heats pure water by irradiating the pure water with light from an infrared lamp.

As the apparatus using induction heating, there is known a heating apparatus in which a heating element to be heated by electromagnetic induction is accommodated in the passage for water. The heating element is configured as follows. For example, a first metal plate folded in zigzag angles and a flat second metal plate are alternately stacked one on another to be a cylindrical lamination as a whole. The material for the metal plate is formed of stainless steel (see, e.g., Japanese Unexamined Patent Application Publication (JP-A) No. 9-168797).

Further, there is known a heating apparatus configured as follows. A bent tube formed of a stainless steel tube and connected to piping at opposite ends, respectively, is provided as a heating element. A coil is disposed around the outside thereof in such a manner as to surround the heating bent tube. By flowing a high frequency current through the coil, the heating bent tube is caused to generate heat, thereby to heat a fluid flowing in the inside thereof (see, e.g., JP-A-2001-235228).

Still further, there is also exemplified a water heater using an induction heating element made of glassy carbon. The water heater is configured as follows. A porous glassy carbon component having a communication hole is used as an induction heating element. Thus, while passing water through the hollow formed inside the glassy carbon component, the glassy carbon component is caused to inductively generate heat, thereby to heat water (see, e.g., Japanese Unexamined Utility Model Application Publication (JP-UM-A) No. 5-59155).

However, with a conventional heating apparatus for indirect heating using resistance heating, the container itself has some heat insulating effect. Therefore, high heating efficiency cannot be expected. Whereas, also for a heating apparatus for direct heating, in order to avoid contamination of pure water by a heater material, it is necessary that the resistance wire is coated with quartz or fluororesin to cover the heater material. Thus, reduction of heating efficiency is unavoidable.

Further, when the covering material undergoes breakage, impurities generated from the heater material contaminate the product. Therefore, in order to avoid abrasion of the covering material, there is a limitation that the heater temperature cannot be set too high. In addition, in order to prevent breakage of the covering material, it is necessary to replace the covering material before breakage occurs. An inspection operation therefor must be frequently carried out, resulting in complicated maintenance of the heating apparatus.

Whereas, for the lamp heating, the heating efficiency is not so high because of the problem of the luminous efficiency and the light absorption coefficient of water. Further, maintenance and inspection are indispensable because the lamp has its life.

Whereas, with the heating apparatus utilizing induction heating, there is a possibility of metal contamination by stainless steel. Thus, the heating apparatus has room for improvement for use as a recent heating apparatus of ultrapure water which is required to have very strict purity.

Still further, an attempt has been made to apply the heating method using the induction heating element made of glassy carbon to pure water heating. Thus, two points to be improved have been identified. The first is the heating efficiency, and the second is the contamination of pure water.

First, the heating efficiency will be described.

When an object is subjected to induction heating, an induced current increases with approach toward the surface of the object, and decreases exponentially toward the inside. This is referred to as the skin effect.

Such a depth that the current value becomes 0.368, when the current value of the outermost surface is 1, is referred to as the electric penetration depth (6, cm), and is calculated by the following equation (1).

δ=5.03×(ρ/μf)½ Equation (1)

where

ρ: specific resistance (μΩcm),

μ: relative magnetic permeability (which is equal to 1 for a non-magnetic material), and

f: frequency (Hz)

Substitution of a general specific resistance value of the glassy carbon of 4500 (μΩcm), and, for example, 430 kHz as a frequency into the equation (1) results in a penetration depth δ of 0.51 cm.

Namely, in the glassy carbon component, the portion which inductively generates heat is the region from the surface to a depth of only 5 mm. This indicates as follows. As with the invention described in JP-UM-A-5-59155, even when a glassy carbon component, which is porous and has a large wall thickness enough to allow passage of water, is caused to inductively generate heat, the heat value of the inside of the component is small. This makes it difficult to heat water with efficiency. Incidentally, when the thickness of the porous glassy carbon component is reduced to as small as about 5 mm, all of the water to be heated cannot be allowed to pass through the hollow, which is unsuitable for heating of a large quantity of water.

Then, the contamination of pure water will be described.

The contamination of pure water is caused by the use of a porous glassy carbon.

The glassy carbon is generally manufactured by heat treating and carbonizing a molded product of a thermosetting resin such as phenol resin in an inert atmosphere. The purity of the glassy carbon is at a very high level due to the recent advance of thermosetting resins and the carbonization technology. However, no matter what a high-purity one is used as the raw material, it is difficult to completely prevent impurity elements from being mixed from environment during molding, carbonizing, or other manufacturing steps.

Thus, considering the case where the glassy carbon is allowed to inductively generate heat, and to heat pure water (is brought in contact with pure water), the impurities contained in the glassy carbon move, although in a very small amount, to pure water (contaminate pure water). Such movement of impurities does not matter for general water heaters, but exerts harmful influences such as a reduction of the yield in VLSI manufacturing.

### SUMMARY OF THE INVENTION

The present invention has been made by finding out the following fact: the foregoing movement of impurities is remarkable when a porous glassy carbon component having a relatively large surface area is used. It is an object of the present invention to provide an induction heating type pure water heating apparatus and a pure water heating method, which can heat pure water with efficiency and without contaminating pure water.

In accordance with a first aspect of the present invention, an induction heating type pure water heating apparatus includes a pure water passage tube formed of glassy carbon with a water absorption coefficient of 0.5 mass % or less, and formed so as to allow pure water to pass through the inside thereof, and an induction coil disposed in such a state as to surround the pure water passage tube or as to be adjacent to the pure water passage tube.

The glassy carbon in the first aspect denotes a close texture substantially not containing bubbles.

Further, in accordance with a second aspect of the present invention, an induction heating type pure water heating apparatus includes a susceptor formed of glassy carbon with a water absorption coefficient of 0.5 mass % or less, and capable of contacting with pure water, a container made of a magnetic flux transmissive material, and formed so as to accommodate the susceptor and so as to allow pure water to pass therethrough, and an induction coil disposed in such a state as to surround the container or as to be adjacent to the container.

The susceptor in the second aspect denotes a component/material which receives energy of a high frequency magnetic field, and generates heat.

In the second aspect, the induction heating type pure water heating apparatus can have at least one tube-like member capable of allowing pure water to pass through the inside thereof, or at least one disc-like member disposed in such a state as to come in contact with pure water as the susceptor.

In accordance with a third aspect of the present invention, a pure water heating method includes: allowing pure water to pass in a tube formed of glassy carbon with a water absorption coefficient of 0.5 mass % or less, or in a container accommodating a susceptor formed of glassy carbon with a water absorption coefficient of 0.5 mass % or less; flowing a high frequency current through an induction coil disposed in such a state as to surround the tube or the container, or as to be adjacent to the tube or the container; and thereby heating the pure water flowing through the tube or the container.

When pure water is allowed to pass through the tube formed of glassy carbon with a water absorption coefficient of 0.5 mass % or less, or the container accommodating a susceptor formed of glassy carbon with a water absorption coefficient of 0.5 mass % or less, it is also possible to heat ultrapure water without contamination.

In accordance with the induction heating type pure water heating apparatus and the pure water heating method of these aspects of the present invention, it is possible to heat from pure water to ultrapure water efficiently without contamination.

### BRIEF DESCRIPTION OF THE DRAWINGS

FIG. 1 is a cross sectional view showing a first configuration of a pure water heating apparatus in accordance with an embodiment of the present invention;

FIG. 2 is a view corresponding to FIG. 1 showing a modified example of a susceptor shown in FIG. 1; and

FIG. 3 is a cross sectional view showing a second configuration of the pure water heating apparatus in accordance with an embodiment of the present invention

### DETAILED DESCRIPTION OF THE PREFERRED EMBODIMENTS

Below, the present invention will be described in details by way of embodiments shown in the accompanying drawings.

An induction heating type pure water heating apparatus of the present invention (which is hereinafter simply abbreviated as a pure water heating apparatus) is characterized in that pure water which is an object to be heated and an induction heating element made of glassy carbon are brought in direct contact with each other for heat exchange.

As the pure water heating apparatuses in which heat exchange is caused, the following are exemplified:

a. A first configuration in which susceptors as induction heating elements are accommodated in a tube-like heating chamber (container), and pure water is allowed to pass into the heating chamber; and

b. Second configuration in which a pure water passage tube itself as an induction heating element is used as a heating chamber, and pure water is allowed to pass into the heating chamber.

Further, with the first and second configurations, the water absorption coefficient of the induction heating element for controlling the contamination of pure water to a low level is set preferably at 0.5 mass % or less, and further preferably 0.1 mass %.

The wall thickness of the induction heating element made of glassy carbon is set desirably at 1 to 5 mm for the following reasons. When it is 1 mm or less, the mechanical strength may be reduced. On the other hand, even when the wall thickness is 5 mm or more, an increase in heat generation efficiency cannot be expected due to the skin effect. In addition, in order to prevent the occurrence of cracking during the carbonization step, a large heating rate within the practical range is demanded.

Whereas, with the pure water heating apparatus of the present invention, pure water is brought in direct contact with the induction heating element to be heated. Therefore, it is possible to more enhance the heating efficiency than with the heating system using resistance heating or lamp heating. Further, the induction heating element will not become exhausted. This can save the component replacing operation, so that the maintenance becomes easy. Whereas, there is another advantage as follows: even if the induction heating element may be broken, pure water will not be contaminated thereby.

Generally, glassy carbon is produced by heating a thermosetting resin molded product of, for example, a phenol resin to a temperature of generally 100° C. or more for carbonization.

The properties characteristic of carbon can be obtained by carbonization at a temperature of generally 800° C. or more. Namely, carbonization of a resin molded product at a temperature of 800° C. or more can result in such a degree of electric conductivity as to be suitable for use as an induction heating element of induction heating.

However, it has been shown that contamination of pure water occurs, although slightly, when the glassy carbon carbonized at a temperature of about 800° C. is used as the induction heating element.

Various studies on the cause have indicated that contamination of pure water is more likely to occur when the glassy carbon molded product has water absorbing property.

There is a correlation between the water absorbing property and the contamination of pure water. The contamination of pure water, specifically, the metal concentration increases with an increase in water absorbing property. This can be considered to be due to the following fact. High water absorbing property results from the large surface area of the glassy carbon molded product due to the presence of voids and the like. A large surface area results in a high degree of inclusion of impurities, so that the included impurities are precipitated.

Thus, by setting the water absorption coefficient at 0.5 mass % or less, and further preferably 0.1 mass % or less, it becomes possible to suppress the contamination of pure water.

In order to control the water absorption coefficient at 0.5 mass % or less, it is essential only that the carbonization treatment temperature is set at 1400° C. or more. For 0.1 mass % or less, it is essential only that the temperature is set at 1600° C. or more.

Incidentally, the water absorption coefficient is defined by carrying out the following measurement method.

Namely, about 10 g of glassy carbon is ground so as to pass through a mesh with an opening of 1 mm, and dried in 200° C. air for 1 hour, and weighed.

Then, the glassy carbon is allowed to stand on a saturated sodium chloride aqueous solution at 25° C. for 48 hours, and weighed again.

The increment in mass (mass %) from the dry weight is referred to as water absorption coefficient.

Whereas, in the first configuration in accordance with the pure water heating apparatus of the present invention, the shape of the susceptor to be accommodated in a heating chamber may be a cylindrical shape disposed along the passage for pure water (cylindrical susceptor). However, the cylindrical shape is not limited to a linear tube, but may be the one having a curved portion such as a U-tube. Further, the heating chamber itself has no particular restriction. It may be, for example, a container in the form of a rectangular parallelepiped, other than the tube.

Still alternatively, an induction heating element in the form of a disc can also be used as a susceptor (disc-like susceptor). In this case, the susceptor may be disposed in the direction crossing with the direction of movement of pure water flowing in the heating chamber. Alternatively, it may be the one having a notch in a part thereof like a propeller.

Incidentally, when the cylindrical (or disc-like) susceptor is disposed in the heating chamber, the number of susceptors to be accommodated therein is not required to be one. A plurality of susceptors can also be accommodated therein.

Incidentally, the pure water passage tube and the susceptor can be manufactured by a known method.

Specifically, they can be manufactured in the following manner. A thermosetting resin such as a phenol resin is used as the raw material. The thermosetting resin is molded into a predetermined shape, and then carbonized. Alternatively, a glassy carbon component in a desired shape is cut by machining from the glassy carbon molded product obtained by carbonizing a thermosetting resin.

Incidentally, other than a phenol resin, for example, a furan resin or a polyimide resin can be used.

Whereas, the material or the shape of the heating chamber for accommodating therein the susceptor has no particular restriction. However, it is preferable to use a pipe made of quartz or made of polyethylene fluoride. In short, any material is acceptable so long as it allows a magnetic flux to pass therethrough.

### EXAMPLES

As a raw material for glassy carbon, liquid phenol resin, PL-4804 manufactured by GUNEI CHEMICAL INDUSTRY Co., Ltd., was used. Incidentally, the characteristics of this raw material are as follows: specific gravity (at 25° C.): 1.198, viscosity (cP, at 25° C.): 690, gelation time (at 150° C.): 7 minutes and 50 seconds, and nonvolatile component (%): 72.5.

The phenol resin was centrifugally molded by the use of a centrifugal molding machine having a cylindrical mold with an inner diameter of 30 mm and a length of 300 mm, resulting in a thermosetting resin cylindrical tube with an outer diameter of 29 mm and a length of 295 mm.

The thermosetting resin cylindrical tube was heated at 250° C. for 50 hours, and completely cured. Then, it was heat treated at different temperatures of 1000° C. to 2000° C. in a nitrogen atmosphere for 5 hours for carbonization, resulting in a cylinder made of glassy carbon with an outer diameter of 25 mm, a wall thickness of 2 mm, and a length of 250 mm (used as a cylindrical susceptor and a pure water passage tube described later).

a. First Configuration of the Present Invention

a-1. Configuration in which a Cylindrical Susceptor is Accommodated in a Heating Chamber

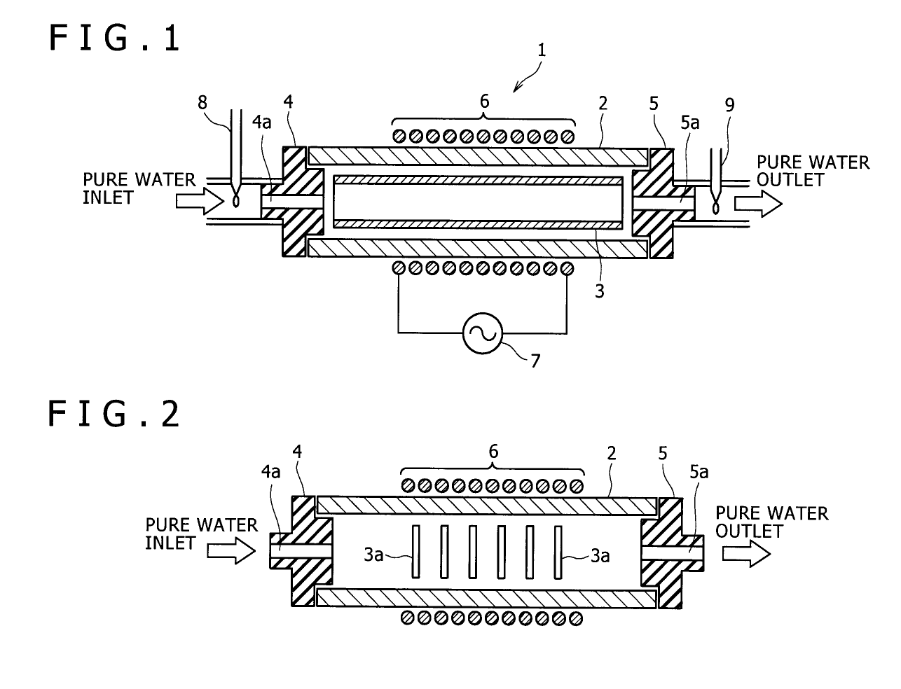

A pure water heating apparatus 1 shown in FIG. 1 shows a configuration for heating ultrapure water as for semiconductor cleaning.

The pure water heating apparatus 1 has a heating chamber (container including a magnetic flux transmissive material) 2 formed of a pipe made of Teflon® with an outer diameter of 40 mm, an inner diameter of 30 mm, and a length of 300 mm. In this heating chamber 2, a cylindrical susceptor formed in a cylinder (tube-like member) 3 is accommodated.

Namely, the heating chamber 2 and the cylindrical susceptor 3 smaller in diameter than the heating chamber 2 are disposed concentrically as seen from the direction of the tube axis.

One end of the heating chamber 2 is closed by a stopper member 4 made of Teflon® and including a pure water inlet portion 4a, and the other end thereof is closed by a stopper member 5 made of Teflon® and including a pure water outlet portion 5a.

It is configured such that ultrapure water is supplied from the pure water inlet portion 4a into the heating chamber 2, and such that heated pure water is discharged from the pure water outlet portion 5a.

Incidentally, the cylindrical susceptor 3 is held by a support not shown in the heating chamber 2. With this configuration, ultrapure water comes in contact with the inner wall and the outer wall of the pure water contact tube 3 to be heated when flowing in a manner divided into the inner surface side and the outer surface side of the cylindrical susceptor 3.

Whereas, by interposing the opposite ends of the cylindrical susceptor 3 by the stopper members 4 and 5, it is also possible to support the pure water contact tube 3. In this case, pure water comes in contact with the inner wall of the pure water contact tube 3 to be heated.

At the pure water inlet portion 4a, a pump is connected via a flow control valve, which allows ultrapure water produced with an ultrapure water production apparatus to be supplied at a set flow rate to the heating chamber 2.

Further, around the outer circumference of the heating chamber 2, there is disposed a high frequency induction coil 6 made of 20 helical turns of a water cooled copper tube with an outer diameter of 6 mm. Incidentally, the helically formed water cooled copper tube has an inner diameter of 50 mm and a coil pitch of 10 mm.

A reference numeral 7 denotes a high frequency power source connected to the high frequency induction coil 6. A reference numeral 8 denotes a temperature sensor for measuring the temperature on the inlet side of the heating chamber 2, and a reference numeral 9 denotes a temperature sensor for measuring the temperature on the outlet side.

By the use of the pure water heating apparatus 1 having the foregoing configuration, while flowing ultrapure water with a water temperature of 25° C. at a flow rate of 2 l/min into the heating chamber 2, a high frequency power was applied to the high frequency induction coil 6 under the conditions of a frequency of 430 kHz, an output of 2 kW, and a current of 5 A. Thus, the water temperatures on the inlet side and on the outlet side of the heating chamber 2 were measured by the temperature sensors 8 and 9, respectively. Further, the water quality on the outlet side, specifically, the metal concentration was measured by means of a mass analysis apparatus SP9000SE manufactured by Seiko Instruments Inc.

Table 1 shows the measured water temperatures and metal concentrations. Incidentally, the numbers in the table indicate the numbers of sample products manufactured at different carbonization temperatures.

TABLE 1
Characteristics of glassy carbon and pure
water heating characteristics

| | Carbonization | Water absorption | | Metal |
|---|---|---|---|---|
| | temperature | coefficient | Outlet water | concentration |
| | (° C.) of | (wt %) of | temperature | (ppb) of |
| No. | glassy carbon | glassy carbon | (° C.) | outlet water |
| 1 | 800 | 3.2 | 88 | 610 |
| 2 | 1000 | 0.9 | 88 | 160 |
| 3 | 1200 | 0.6 | 86 | 41 |
| 4 | 1400 | 0.4 | 85 | 8.3 |
| 5 | 1600 | 0.1 | 86 | 0.4 |
| 6 | 2000 | <0.001 | 86 | <0.1 |
| 7 | 2200 | <0.001 | 86 | <0.1 |

As indicated from Table 1, it was possible to heat ultrapure water to 80° C. or more for all the sample products irrespective of the carbonization temperature of glassy carbon.

However, for Nos. 1 to 3 having a water absorption coefficient of glassy carbon of 0.6 to 3.2 mass %, each concentration of metal contained in the heated ultrapure water was relatively as high as 41 to 610 ppb.

On the other hand, for Nos. 4 to 7 having a water absorption coefficient of 0.4 mass % or less, each concentration of metal contained in the heated ultrapure water showed a very low value of 8.3 ppb or less. By this, it has been possible to confirm that the heated samples are suitable as heated ultrapure water.

As the metals to be precipitated from ultrapure water, specifically, there are shown iron, selenium, nickel, sodium, copper, and the like. These metals are contained in the resin of the glassy carbon raw material. Alternatively, presumably, they have been mixed from environment during the resin production step.

Whereas, as shown with Nos. 5 to 7, for the glassy carbon having a water absorption coefficient of 0.1 mass % or less, the metal concentration is 0.4 ppb or less. This is generally equal to the metal concentration (1 ppb) of ultrapure water required for semiconductor manufacturing. This indicates that there is no risk that ultrapure water is contaminated thereby.

Incidentally, 1 ppb is the concentration when 1 μg of impurities are present in 1 m³ of water. Whereas, the metal concentration of the outlet pure water is measured after 10 minutes from the start of heating and flowing.

a-2. Configuration in which a Disc-Like Susceptor is Accommodated in a Heating Chamber

FIG. 2 shows a modified example of a susceptor to be accommodated in the heating chamber 2. Incidentally, in the same drawing, the same constitutional elements as those in FIG. 1 are given the same numerals and signs, and a description thereon is omitted.

The disc-like susceptors 3a shown in FIG. 2 are respectively formed of discs made of glassy carbon and having the same size. These are arranged in the direction of the tube axis of the heating chamber 2 formed of a cylinder made of quartz.

Specifically, inside the heating chamber 2 capable of allowing pure water to pass therethrough, a plurality of disc-like susceptors 3a are arranged so that the center axis is concentric with the center axis of the heating chamber 2. A high frequency induction coil 6 is wound around the heating chamber 2. Incidentally, each disc-like susceptor 3a is held by a support not shown in the heating chamber 2.

With this configuration, the disc-like susceptors 3a inductively generate heat by a high frequency magnetic field arising from the high frequency induction coil 6. This heats pure water flowing in the heating chamber 2. However, the disc-like susceptors 3a are arranged in the direction orthogonal to the passage for pure water. Therefore, turbulent flow occurs in the heating chamber 2, which can increase the heat exchange efficiency between the disc-like susceptors 3a and pure water.

Whereas, when the disc-like susceptors 3a are formed of glassy carbon with a small water absorption coefficient, and causing less contamination as described above, it becomes possible to minimize mixing of impurities into pure water.

b. Second Configuration of the Present Invention

The case where the heating chamber is formed of a pure water passage tube

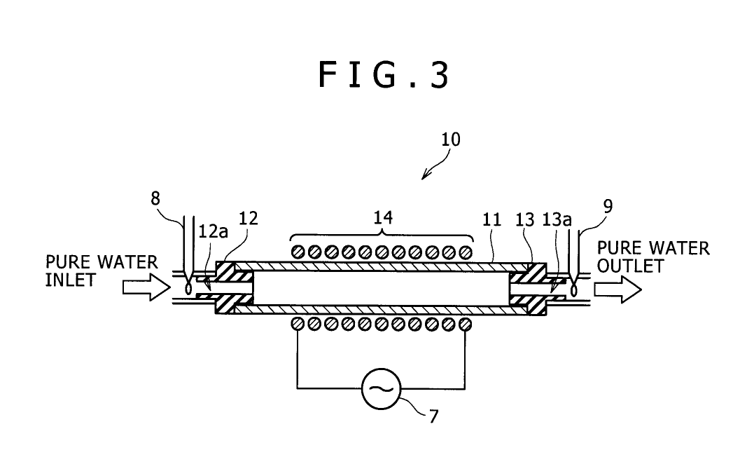

FIG. 3 shows a configuration of a pure water heating apparatus using the cylinder made of glassy carbon with an outer diameter of 25 mm, a wall thickness of 2 mm, and a length of 250 mm as a heating chamber.

In the same drawing, in the pure water heating apparatus 10, a pure water passage tube formed of a cylinder made of glassy carbon forms a heating chamber 11. The heating chamber 11 itself functions as an induction heating element.

One end of the heating chamber 10 is closed by a stopper member 12 made of Teflon® and including a pure water inlet portion 12a, and the other end thereof is closed by a stopper member 13 made of Teflon® and including a pure water outlet portion 13a.

It is configured such that ultrapure water is supplied from the pure water inlet portion 12a into the heating chamber 11, and such that heated pure water is discharged from the pure water outlet portion 13a.

Whereas, around the outer circumference of the heating chamber 11, a water cooled copper tube with an outer diameter of 6 mm was helically wound in 20 turns with an inner diameter of 50 mm and a coil pitch of 10 mm, resulting in a high frequency induction coil 14.

By the use of the pure water heating apparatus 10 having the foregoing configuration, while flowing ultrapure water with a water temperature of 25° C. at a flow rate of 2 l/min into the heating chamber 11, a high frequency power was applied to the high frequency induction coil 14 under the conditions of a frequency of 430 kHz, an output of 2 kW, and a current of 5 A. Thus, the water temperatures on the upstream side and on the downstream side of the heating chamber 11 were measured by the temperature sensors 8 and 9, respectively. Further, the water quality on the outlet side (metal concentration) was measured.

Table 2 shows the measured water temperatures and metal concentrations.

TABLE 2

| | Carbonization | Water absorption | | Metal |
|---|---|---|---|---|
| | temperature | coefficient | Outlet water | concentration |
| | (° C.) of | (wt %) of | temperature | (ppb) of |
| No. | glassy carbon | glassy carbon | (° C.) | outlet water |
| 8 | 800 | 3.2 | 85 | 230 |
| 9 | 1000 | 0.9 | 86 | 52 |
| 10 | 1200 | 0.6 | 85 | 16 |
| 11 | 1400 | 0.4 | 86 | 3.9 |
| 12 | 1600 | 0.1 | 84 | 0.2 |
| 13 | 2000 | <0.001 | 83 | <0.1 |
| 14 | 2200 | <0.001 | 83 | <0.1 |

As indicated from Table 2, it was possible to heat ultrapure water to 80° C. or more for all the sample products irrespective of the carbonization temperature of glassy carbon.

However, for Nos. 8 to 10 having a water absorption coefficient of glassy carbon of 0.6 to 3.2 mass %, each concentration of metal contained in the heated ultrapure water was relatively as high as 16 to 230 ppb.

On the other hand, for Nos. 11 to 14 having a water absorption coefficient of 0.4 mass % or less, each concentration of metal contained in the heated ultrapure water showed a very low value of 3.9 ppb or less. By this, it has been possible to confirm that the heated samples are suitable as heated ultrapure water.

Whereas, as shown with Nos. 12 to 14, for the glassy carbon having a water absorption coefficient of 0.1 mass % or less, the metal concentration is 0.2 ppb or less. This is generally equal to the metal concentration (1 ppb) of ultrapure water required for semiconductor manufacturing. This indicates that there is no risk that ultrapure water is contaminated thereby.

Incidentally, the metal concentration of the outlet pure water is measured after 10 minutes from the start of heating and flowing.

Further, with the configuration of the pure water heating apparatus shown in FIG. 3, it is possible to simplify the structure while obtaining roughly the same heating efficiency as compared with the configuration shown in FIG. 1.

Still further, with the configurations shown in FIGS. 1 to 3, the high frequency induction coil 6 was wound around (was caused to surround) the heating chamber. However, the present invention is not limited thereto, and a configuration in which the high frequency induction coil 6 is adjacent to the vicinity of the heating chamber is also acceptable.

Incidentally, the pure water heating apparatuses with the first and second configurations can be respectively used for cleaning of semiconductors in the semiconductor manufacturing field, for washing of food containers or the like in the food processing field, and for cleaning of inspection apparatuses, surgical instruments, or the like in the medical field.

It should be understood by those skilled in the art that various modifications, combinations, sub-combinations, and alternations may occur depending on the design requirements and other factors insofar as they are within the scope and spirit of the appended claims or the equivalents thereof.

What is claimed is:

1. An induction heating type pure water heating apparatus comprising a pure water passage tube formed of glassy carbon with a water absorption coefficient of 0.5 mass % or less, and formed so as to allow pure water to pass through the inside thereof, and an induction coil disposed in such a state as to surround the pure water passage tube or as to be adjacent to the pure water passage tube.

2. An induction heating type pure water heating apparatus comprising a susceptor formed of glassy carbon with a water absorption coefficient of 0.5 mass % or less, and capable of contacting with pure water, a container made of a magnetic flux transmissive material, and formed so as to accommodate the susceptor and so as to allow pure water to pass therethrough, and an induction coil disposed in such a state as to surround the container or as to be adjacent to the container.

3. The induction heating type pure water heating apparatus according to claim 2, having at least one tube-like member capable of allowing pure water to pass through the inside thereof, or at least one disc-like member disposed in such a state as to come in contact with pure water as the susceptor.

4. A pure water heating method comprising: allowing pure water to pass in a tube formed of glassy carbon with a water absorption coefficient of 0.5 mass % or less, or in a container accommodating a susceptor formed of glassy carbon with a water absorption coefficient of 0.5 mass % or less; flowing a high frequency current through an induction coil disposed in such a state as to surround the tube or the container, or as to be adjacent to the tube or the container; and thereby heating the pure water flowing through the tube or the container.
